(19) United States
(12) Patent Application Publication
(10) Pub. No.: US 2006/0143482 A1
(43) Pub. Date: Jun. 29, 2006

(54) Methods and devices for controlling the distribution of power on a printed circuit board

(76) Inventors: David R. LaChapelle, Millis, MA (US); Douglas Anthony Maclntyre, Berlin, MA (US)

Correspondence Address: HARNESS, DICKEY & PIERCE, P.L.C., P.O. BOX 8910, RESTON, VA, 20195, US

(21) Appl. No.: 11/019,516

(22) Filed: Dec. 23, 2004

(51) Int. Cl. G06F 1/26

(52) U.S. Cl. 713/300

(57) ABSTRACT

A mixed signal controller (MSC) is used to vary the rise times and trim voltages used on a printed circuit (PC) board. The use of an MSC reduces the number of components on a PC board which may reduce the complexity, cost and size of the PC board.

### BACKGROUND OF THE INVENTION

Printed circuit (PC) boards are a part of almost every kind of electronic device. On each PC board there may be many integrated circuits (IC). Each IC is powered using a so-called “core” voltage and an input/output (I/O) voltage.

The core and I/O voltages are typically supplied by direct current (DC)-to-direct current (DC) converters which are also placed on a PC board.

To operate a PC board with many ICs, each of the ICs must be supplied with an appropriate core and I/O voltage. Complicating matters, depending on the type of IC, the core voltage and I/O voltage required by one IC may not be the same as the core voltage and I/O voltage required by another IC. Said another way, many different core and I/O voltages may be needed for a single PC board.

Power is not instantaneously supplied to an IC. Instead, it takes a certain time period, called a rise time, for a core voltage or I/O voltage level to rise up to a level required by an IC. Similar to the explanation above, different ICs may have different rise times. That is, it may take a longer period of time for one IC to reach its core or I/O voltage (referred to as a “trim voltage”) than another IC. In sum, different ICs may have different rise times.

Yet still further complicating matters, it is sometimes desirable to change the rise times and trim voltages of core and I/O voltages.

In order to supply varying rise times and trim voltages and to account for the possibility of the need to change these voltages and parameters, existing techniques require the use of extra components. These additional components require additional space on a PC board, may raise the cost of a PC board, and may require a larger or more complicated PC board.

It is, therefore, desirable to provide for methods and devices which are capable of providing a range of rise times and trim voltages for core and I/O voltages without the need to increase the size of, or take up additional space on, a PC board while potentially reducing the cost of such a PC board.

### BRIEF SUMMARY OF THE INVENTION

We have recognized that it is possible to provide a wide range of rise times and trim voltages for core and I/O voltages by providing an apparatus, such as a mixed signal controller (“MSC”), that is capable of controlling the distribution of power (e.g., voltages) on a PC board. The use of an MSC instead of additional electronic components substantially reduces the number of components needed to provide the many core and I/O voltages that may be needed by a PC board. In addition, the use of an MSC may substantially reduce the space required on a PC board. The reduction in the number of components and space may in turn lead to a reduction in cost and in the overall size of a PC board.

In accordance with one aspect of the present invention, an MSC comprises program code sections which are operable to store program code for carrying out functions and features related to the control of core and I/O voltages supplied to ICs located in different portions of a PC board.

One program code section may be operable to control the voltage rise time and trim voltage level of voltages generated by one or more DC-to-DC converters. Another, or the same program code section, may be operable to control the selection of one or more electronic switches (e.g., power MOSFETs), where each selected switch is operable to receive controlled voltages output by one of the DC-to-DC converters. An electronic switch that is so selected may distribute a received, controlled voltage to one or more ICs located on portions of a PC board.

The MSCs provided by the present invention may be adjusted (e.g., reprogrammed) when necessary to allow for the generation of new core or I/O voltages using different rise times or trim voltage levels. Such adjustments may be done in software, firmware, hardware or some combination of the three.

### BRIEF DESCRIPTION OF THE ILLUSTRATIVE DRAWINGS

FIG. 1 illustrates a simplified block diagram of components of a PC board which may be used to control the distribution of power to ICs on the PC board according to one embodiment of the present invention.

### AN EXPLANATION OF THE PRESENT INVENTION USING EXAMPLES

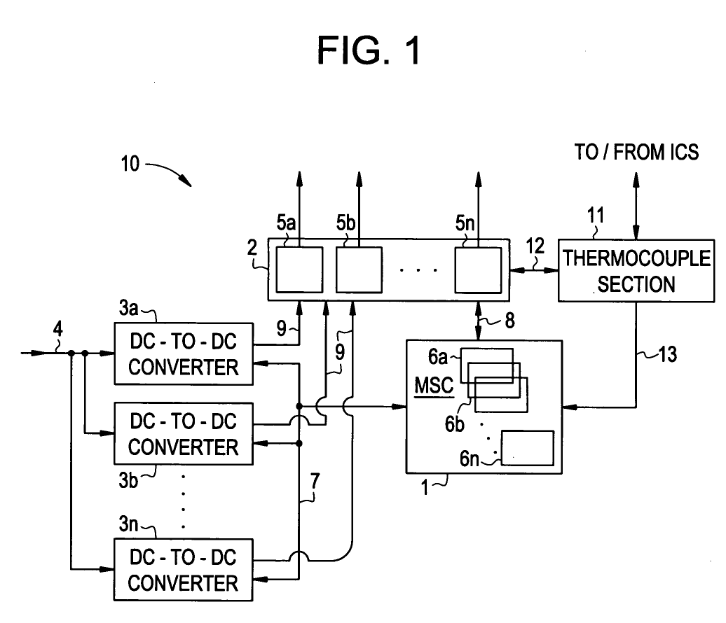

Referring to FIG. 1, there is shown a simplified block diagram of a PC board 10 which comprises an MSC 1, switch bank 2, DC-to-DC converters 3a,3b, . . . 3n (where n is the last converter), power supply bus 4 (e.g., an intermediate power supply bus) and a thermocouple section 11. The PC board 10 may be a part of a device that is used in a telephone or telecommunications central office (CO). As is recognized by those skilled in the art, some PCs are required to use isolated power while other PCs can use non-isolated power. In accordance with one example of the present invention, the power supplied by bus 4 and DC-to-DC converters 3a,3b, . . . 3n is non-isolated.

Switch bank 2 may comprise one or more electronic switches 5a,5b, . . . 5n, such as power MOSFETs. Each MOSFET may be connected to one or more portions (not shown) of the PC board 10 which in turn contains one or more types of ICs. Each of the electronic switches or MOSFETs is responsible for the distribution of power to one or more such portions.

In accordance with one example of the present invention, the MSC 1 is operable to control which electronic switches 5a,5b . . . . 5n are selected and powered up. In addition, the MSC 1 is operable to control (e.g., adjust) the voltage rise times and trim voltages of core and I/O voltages generated by the DC-to-DC converters 3a,3b, . . . 3n that are to be supplied to the switches 5a,5b, . . . 5n. Unlike existing techniques, there is no need to include any number of additional components, etc. to make such adjustments.

In more detail, the MSC 1 may comprise one or more program code sections 6a,6b . . . . 6n. Each section is operable to carry out features and functions related to the control and distribution of power to the PC board 10. For example, program code section 6a may be operable to control the voltage rise time and trim voltage level of voltages generated by one or more of the DC-to-DC converters 3a,3b, . . . 3n, while program code section 6b may be operable to control the selection of one or more of the electronic switches 5a,5b, . . . 5n. If an electronic switch 5a,5b, . . . 5n is selected by section 6b, then such a switch is in effect powered up and is thereafter operable to receive controlled voltages (e.g., a core voltage and an I/O voltage) output by one of the DC-to-DC converters 3a,3b, . . . 3n. The so powered-up switch may then distribute the controlled voltage to one or more portions of the PC board 10. If, however, an electronic switch 5a,5b, . . . 5n is not selected by section 6b, then such a switch is not powered up and cannot make use of voltages generated by one of the DC-to-DC converters 3a,3b . . . 3n to distribute power to a portion of the PC board 10.

Though code sections 6a and 6b are shown as separate sections, it should be understood that these sections may be combined to form one section. In general, the MSC 1 may be made up of one or many code sections 6a,6b, . . . 6n. Each code section may further comprise program code in the form of software or firmware or may be realized in hardware or, alternatively, each code section 6a,6b, . . . 6n may be realized in a combination of hardware, software and firmware.

The program code sections 6a,6b, . . . 6n may be a part of one or more programmable mediums, such as a memory device or memory section.

It should be understood that the MSC 1 is capable of inputting and outputting both digital and analog signals. That is, the voltage levels of signals received by, and sent from, the MSC 1 may include both standard logic voltages and non-standard voltages.

Sometimes it is desirable to power up one or more of the electronic switches 5a,5b, . . . 5n at the same time, using the same (or different) rise times and/or trim voltages. To allow for this scenario, in another embodiment of the present invention, one or more program code sections 6a,6b, . . . 6n may be operable to control one or more of the voltage rise times and/or trim voltages of the core and/or I/O voltages being supplied to two or more of the electronic switches 5a,5b, . . . 5n by converters 3a,3b, . . . 3n such that the rise times and/or the trim voltages are substantially the same.

In sum, the MSC 1 can ensure that two or more of the electronic switches 5a,5b . . . . 5n receive the same trim voltage within the same time period by controlling the rise times and trim voltage levels output by one or more of the DC-to-DC converters 3a,3b, . . . 3n.

In addition to powering up electronic switches using the same rise times and trim voltages, it is sometimes desirable to power up electronic switches in a determined order. That is, a particular PC board may contain a number of ICs which should be powered up in a determined order to achieve a particular mode of operation. Realizing this, the present invention provides for one or more program code sections 6a,6b, . . . 6n for controlling the selection of one or more electronic switches 5a,5b, . . . 5n in a determined order. Because the switches 5a,5b, . . . 5n in turn control the distribution of power to portions of the PC board 10, the order in which the switches 5a,5b . . . . 5n are powered up may also dictate the order in which portions of the PC board 10 receive power. The particular order in which electronic switches are selected, and therefore powered up (or off), may be stored within a program code section 6a,6b, . . . 6n or stored within another section (not shown) of the MSC 1 or another memory device (not shown) on the PC board 10. This order may be varied or adjusted using firmware, software, hardware or some combination of the three.

Further, the MSC 1 may comprise one or more program sections operable to detect when adjustments are needed.

Backtracking somewhat, the trim voltage levels output by the DC-to-DC converters 3a,3b, . . . 3n may comprise a number of levels. For example, a trim voltage may be in the range of 1.5 volts to 3.3 volts. Alternatively, a trim voltage may be 0.70 volts, 1.2 volts or 5 volts. In accordance with another example of the present invention, a trim voltage must be at least 0.70 volts.

Similarly, the voltage supplied by the power supply bus 4 may vary. In one example, the voltage level may be 5 volts; in yet another example it may be 12 volts. To distinguish the voltage being supplied by the power supply bus 4 from the voltages being output from the DC-to-DC converters 3a,3b, . . . 3n, the voltage being supplied by the power bus 4 will be referred to as a “first” voltage while the voltages being generated by the DC-to-DC converters 3a,3b, . . . 3n will be referred to as “second” voltages.

Turning now to the operation of the DC-to-DC converters 3a,3b . . . . 3n, each of the converters is operable to supply one or more controlled, DC voltages. More specifically, each of the DC-to-DC converters is operable to receive a first, DC voltage from the power bus 4 and convert it to a second DC voltage using conversion techniques known by those skilled in the art. This second DC voltage (e.g., core voltage or I/O voltage) is generated in accordance with a voltage control signal received from the MSC 1 along pathway(s) 7 or the like. After the second DC voltage is generated, it is supplied to one or more selected electronic switches 5a,5b . . . . 5n.

The voltage control signal which is sent along pathway 7 may comprise both a voltage rise time signal portion and a trim voltage signal portion; the former being used to control the rise time of a second voltage while the latter is used to control a trim voltage level of a second voltage.

If the MSC 1 sends the same voltage control signal to two or more DC-to-DC converters, then the so-targeted converters may be operable to generate the same, converted second voltage. That is, two or more of the DC-to-DC converters 3a,3b . . . . 3n may generate a core and/or I/O voltage which has the same rise time and trim voltage. Alternatively, the control signal may be used by the converters 3a,3b, . . . 3n to generate voltages that have the same rise times, or the same trim voltage levels.

Turning now to the switch bank 2, as indicated above, the switch bank 2 comprises one or more electronic switches 5a,5b . . . . 5n. In accordance with the present invention, each of these electronic switches 5a,5b, . . . 5n may be operable to receive a selection signal along pathway(s) 8. This selection signal enables a particular electronic switch to be powered up (i.e., turned on). In one example of the present invention, each electronic switch comprises a power MOSFET which has a gain, source and drain portion. The selection signals which are sent over pathway 8 may be received by each of the electronic switches at their gate portions.

Upon receipt of a selection signal, an electronic switch 5a,5b, . . . 5n is powered up and, thereafter, reaches a core or I/O voltage level supplied from one or more of the DC-to-DC converters 3a,3b, . . . 3n along pathway(s) 9. It should be understood that the voltages being received on pathway 9 from one or more DC-to-DC converters 3a,3b, . . . 3n are controlled voltages. That is, they are voltages whose rise times and trim levels have been controlled or determined by the MSC 1.

The controlled voltages (either core or I/O) may be received by each of the electronic switches 5a,5b, . . . 5n at the source and drain portions of each electronic switch.

Upon receipt of a controlled voltage, an electronic switch 5a,5b . . . . 5n is operable to distribute such a voltage to one or more portions of the PC board 10 (not shown).

Again, as indicated above, it may be desirable to power up the electronic switches 5a,5b . . . . 5n in a determined order. When this is desirable, two or more of the switches 5a,5b, . . . 5n may be operable to receive a selection signal and a controlled voltage in such a determined order and, thereafter, distribute the controlled voltage to one or more portions of the PC board 10.

The use of an MSC, in combination with DC-to-DC converters and electronic switches may also be used to carry out other functions over and above the adjustment of rise times and trim voltages. For example, such a combination may be used to carry out hardware verification tests (“HVTs”). Such HVTs are typically carried out before a PC board, or its related electronic device, is placed into routine operation (i.e., before it is sold or installed into a CO).

As is known by those skilled in the art, it is often necessary to ensure that ICs on a given PC board can operate effectively over a wide range of temperatures. HVTs may be used to verify an IC's operation. One HVTs test involves placing a PC board in an oven or the like and then adjusting the air temperature of the oven, which in turn causes the temperature of the PC board (and the ICs on the PC board) to rise or fall accordingly. When the temperature of an IC changes it may be necessary to verify that the IC still operates over a range of core and/or I/O voltages. In accordance with a further example of the present invention, the core and I/O voltages of a given IC may be varied as desired using MSCs provided by the present invention as the temperature of a given IC is varied.

In addition to HVTs, it may also be desirable to monitor the temperature of a given IC after it has been placed into service (e.g., put into a device, CO, etc. That is, while in operation an IC's temperature may change. For example, environmental conditions inside a CO may affect an IC's temperature. Also, as ICs get older and the material which they are made from gets depleted or otherwise weakens, an IC's operating temperature may change. If the temperature of an IC changes, this may affect the operating voltage of an IC and, thus, the overall operation of a PC board, etc.

Accordingly, a thermocouple section 11 may be used to monitor the operating temperature of one or more ICs. The temperatures measured by the thermocouple section 11 may be sent to the MSC 1 via pathway(s) 13. The MSC 1 may be further operable to analyze the respective temperatures.

As before, the temperature analysis can be carried out by one or more of the program code sections 6a,6b . . . . 6n. In addition, any needed adjustment to a rise time or trim voltage level dictated by a temperature change may be initiated by one or more of the sections 6a,6b, . . . 6n.

The above discussion has attempted to set forth some examples of the present invention. However, it should be understood, that the true scope of the present invention is given by the claims which follow.

We claim:

1. A device for controlling the distribution of power on a printed circuit board comprising:
a program code section operable to control the voltage rise time and trim voltage level of one or more voltages generated by one or more direct current (DC)-to-direct current (DC) converters; and
a program code section operable to control the selection of one or more electronic switches, each selected switch operable to receive one or more of the generated, controlled voltages.

2. The device as in claim 1 wherein the generated voltages include a core voltage and an input/output (I/O) voltage.

3. The device as in claim 1 further comprising a program code section operable to control voltage rise times of voltages generated by two or more of the DC-to-DC converters such that the rise times are substantially the same.

4. The device as in claim 1 further comprising a program code section operable to control trim voltage levels of voltages generated by two or more of the DC-to-DC converters such that the trim voltage levels are substantially the same.

5. The device as in claim 1 further comprising a program code section operable to control the selection of one or more of the switches using a variable, determined order.

6. The device as in claim 1 wherein the device comprises a mixed signal controller.

7. The device as in claim 1 wherein a generated, controlled voltage is at least 0.70 volts.

8. A device for distributing controlled, direct current (DC) voltages to one or more portions of a printed circuit board comprising:
one or more electronic switches operable to receive a selection signal and one or more controlled voltages and to distribute received, controlled voltages to a portion of a printed circuit board upon receipt of the selection signal.

9. The device as in claim 8 wherein the device comprises a switch bank.

10. The device as in claim 8 wherein each of the switches comprises a MOSFET.

11. The device as in claim 8 wherein two or more of the switches are operable to receive a selection signal and one or more controlled voltages in a variable, determined order and to distribute one or more of the received, controlled voltages to one or more portions of the printed circuit board.

12. A device for generating one or more controlled, direct current (DC) voltages for use by a printed circuit board comprising:
one or more DC-to-DC converters, each converter operable to receive a first DC voltage and convert it to a second DC voltage in accordance with a received voltage control signal and further operable to supply the second DC voltage to one or more electronic switches.

13. The device as in claim 12 wherein the one or more DC-to-DC converters comprise non-isolated converters.

14. The device as in claim 12 wherein the voltage control signal comprises a voltage rise time signal portion and a trim voltage signal portion.

15. The device as in claim 1 further comprising:
a thermocouple section operable to detect a temperature of one or more ICs and to forward detected temperatures on to a program code section; and
a program code section operable to receive the detected temperatures and to determine whether the detected temperatures indicate a change in temperature of one or more of the ICs.

16. A method for controlling the distribution of power on a printed circuit board comprising:
controlling the voltage rise time and trim voltage level of one or more voltages generated by one or more direct current (DC)-to-direct current (DC) converters; and
controlling the selection of one or more electronic switches, each selected switch operable to receive one or more of the generated, controlled voltages.

17. The method as in claim 16 further comprising controlling voltage rise times of voltages generated by two or more of the DC-to-DC converters such that the rise times are substantially the same.

18. The method as in claim 16 further comprising controlling trim voltage levels of voltages generated by two or more of the DC-to-DC converters such that the trim voltage levels are substantially the same.

19. The method as in claim 16 further comprising controlling the selection of one or more of the switches using a variable, determined order.

20. The method as in claim 16 further comprising:
receiving a selection signal and one or more controlled voltages; and
distributing received, controlled voltages to a portion of a printed circuit board upon receipt of the selection signal.

21. The method as in claim 20 further comprising:
receiving the selection signal and one or more of the controlled voltages in a variable, determined order; and
distributing one or more of the received, controlled voltages to one or more portions of the printed circuit board.

22. The method as in claim 16 further comprising:
receiving a first DC voltage;
receiving a voltage control signal;
converting the first voltage to a second DC voltage in accordance with the received voltage control signal; and
supplying the second DC voltage to one or more electronic switches.

23. The method as in claim 22 wherein the voltage control signal comprises a voltage rise time signal portion and a trim voltage signal portion.

24. The method as in claim 16 further comprising:
detecting a temperature of one or more ICs; and
determining whether the detected temperatures indicate a change in temperature of one or more of the ICs.
